(19) United States
(12) Patent Application Publication
(10) Pub. No.: US 2006/0034043 A1
(43) Pub. Date: Feb. 16, 2006

(54) Electronic device, control method, and control program

(76) Inventors: Katsumi Hisano, Matsudo-shi (JP); Masanori Ozawa, Kawasaki-shi (JP); Ryo Furukawa, Kawasaki-shi (JP); Minoru Mukai, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/198,302

(22) Filed: Aug. 8, 2005

(30) Foreign Application Priority Data
Aug. 10, 2004 (JP) P2004-232974

(51) Int. Cl. G06F 1/16

(52) U.S. Cl. 361/681; 248/917; 345/905

(57) ABSTRACT

An electronic device includes a first display device having a display screen, an input device for acquiring a first information indicating a touch position on the display screen, a storing device for storing emulation information used to convert the first information into a second information indicating a touch position on an operating system, and a converting means for converting the first information indicating the touch position acquired by the input device into the second information indicating the touch position on the operating system, based on the emulation information stored in the storing device.

### CROSS REFERENCE TO RELATED APPLICATIONS

This application is based upon and claims the benefit of priority from the prior Japanese Patent Application No. 2004-232974, filed on Aug. 10, 2004, the entire contents of which is incorporated herein by reference.

### BACKGROUND OF THE INVENTION

1. Field of the Invention

The present invention relates to an electronic device, a control method, and a control program and, more particularly, an electronic device capable of inputting information in various modes, a control method for this electronic device, and a control program for executing this control method.

2. Description of the Related Art

The display (LCD) for displaying characters, figures, etc. on a liquid crystal panel and the keyboard on which a plurality of keys used to input the characters are arranged are provided to the normal notebook personal computer. The display and the keyboard are installed into the enclosure respectively, and two enclosures are jointed swingably by hinges. When the notebook personal computer (abbreviated as the “notebook PC” hereinafter) is put on a desk after a swinging angle of the hinges is adjusted appropriately, the input plane of the keyboard is placed in almost parallel with a top surface of the desk and then a display panel of the display is positioned to face to the user.

The user inputs the characters by using the keyboard or moves a cursor by using the mouse. Also, sometimes a pointing device called a touch panel, which can move the cursor when stroked by the tip of a finger, is provided onto the same housing surface, on which keys of the keyboard are arranged. Also, in some cases, another pointing device called a stick provided near a center of the keyboard is provided in addition to the touch pad. The stick can move the cursor when the finger applies a force to the stick (see FIG. 1 of Patent Application Publication (KOKAI) 2003-91333, for example).

Meanwhile, for example, in the paragraphs [0029] and [0030] of Patent Application Publication (KOKAI) 2003-196012 and the paragraphs [0044] and [0049] and FIG. 5 of Patent Application Publication (KOKAI) 2003-280622, the electronic display device having two displays and capable of display two screens is disclosed. In this electronic display device, for example, one page of the book can be displayed on one screen and the next page or the preceding page can be displayed on the other screen.

The notebook PC is the information terminal device that can be carried in use and is excellent in portability. It is desired that a dimension of the enclosure should be set small to improve the portability. In this case, a display area of the display is narrowed when the dimension of the enclosure is reduced. Also, the versatility of the notebook PC is lost if the keyboard whose key arrangement and the number of keys are extremely different from the standard type is loaded. Therefore, a key arrangement pitch of the keyboard is reduced as the dimension of the enclosure is reduced. For this reason, in purchasing the notebook PC, the user chooses either of a full-size notebook PC, which has a large enclosure, a wide screen, and the almost same key arrangement pitch as the desktop personal computer and thus is inferior in the portability, and an easy-carry notebook PC, which has a small enclosure for mobile use, a small screen, and the small key arrangement pitch and the small touch pad area and thus is inferior in the human interface. In this manner, it is difficult for the notebook PC to attain both the portability and the ease of use.

Also, in the notebook PC equipped with the touch pad, the user must move the cursor on the screen by moving his or her finger within a considerably small area rather than the screen. According to the stick, the user must control a force of the finger to move a position of the cursor. Therefore, the touch pad or the stick is inferior in operability to the mouse that is attached externally to the notebook PC and can control a movement of the cursor by a larger motion than the touch pad. In this manner, there is a limit to the operability of the pointing device built-in the notebook PC.

Also, in addition to the case where the user operates personally the notebook PC, the user must shows the person other than the user the information stored in the inside of the notebook PC, or the user must let the person other than the user execute a simple operation. In such case, the full keyboard is not always needed in the destination place to which the notebook PC is carried. In addition, the full keyboard induces the input error in the inexperienced person other than the user since it has a number of keys. That is, in the notebook PC, only one input mode is present in the using situation and the using environment.

Also, since the keyboard in the notebook PC employs the mechanical inputting mechanism, the key touch sound is generated in inputting the data via the keyboard. Therefore, it is difficult to employ the notebook PC in the quiet environment such as the library, school hours in the school, and the like.

### BRIEF SUMMARY OF THE INVENTION

The present invention has been made in view of above problems, and it is an object of the present invention to provide an electronic device that is excellent in portability, operability, situation adaptability, and quietness, a control method, and a control program.

According to a first aspect according to an embodiment of the present invention, there is provided an electronic device, which includes a first display device having a display screen; an input device configured to acquire a first information indicating a touch position on the display screen; a storing device configured to emulation information used to convert the first information into a second information indicating a touch position on an operating system; and a converting unit configured to convert the first information indicating the touch position acquired by the input device into the second information indicating the touch position on the operating system, based on the emulation information stored in the storing device.

According to a second aspect according to the embodiment of the present invention, there is provided an electronic device control method, which includes displaying an input interface screen on a display screen of a first display device; acquiring a position that is touched in an input device on the input interface screen, as a first information; storing an emulation information used to convert the first information into a second information indicating a touched position on an operating system; and converting the first information into the second-information indicating the touched position on the operating system, based on the emulation information.

According to a third aspect according to the embodiment of the present invention, there is provided an electronic device control program, which includes displaying an input interface screen on a display screen of a first display device; acquiring a position that is touched in an input device on the input interface screen, as a first information; storing an emulation information used to convert the first information into a second information indicating a touched position on an operating system; and converting the first information into the second information indicating the touched position on the operating system, based on the emulation information.

### BRIEF DESCRIPTION OF THE SEVERAL VIEWS OF THE DRAWINGS

FIG. 1A is a perspective view of an electronic device according to a present embodiment of the present invention;

FIG. 1B is a schematic sectional view of the electronic device shown in FIG. LA;

FIG. 2 is a functional block diagram of a configuration of the electronic device shown in FIG. 1A;

FIG. 3 is a functional block diagram of another configuration of the electronic device shown in FIG. 1A;

FIG. 4 is a functional block diagram of a CPU configuration of the electronic device shown in FIG. 1A;

FIGS. 5A and 5B are a flowchart showing an operation in starting the electronic device shown in FIG. 1A respectively;

FIGS. 6A and 6B are a flowchart showing an operation in starting application software of the electronic device shown in FIG. 1A respectively;

FIG. 7 is a flowchart showing an operation of acquiring emulation information of the electronic device shown in FIG. 1A;

FIG. 8 is a view showing an example of the emulation information of the electronic device shown in FIG. 1A;

FIG. 9 is a perspective view explaining a using mode of the electronic device according to a first example of the present embodiment;

FIG. 10 is a perspective view explaining a using mode of the electronic device according to a second example;

FIG. 11 is a perspective view explaining a using mode of the electronic device according to a third example;

FIG. 12 is a perspective view explaining a using mode of the electronic device according to a fourth example;

FIG. 13 is a perspective view explaining a using mode of the electronic device according to a fifth example;

FIG. 14 is a perspective view explaining a using mode of the electronic device according to a sixth example;

FIGS. 15A and 15B are perspective views explaining a using mode of the electronic device according to a seventh example;

FIG. 16 is a perspective view explaining a using mode of the electronic device according to an eighth example;

FIGS. 17A and 17B are perspective views explaining a using mode of the electronic device according to a ninth example;

FIG. 18 is a perspective view explaining a using mode of the electronic device according to a tenth example; and

FIG. 19 is a flowchart explaining the using mode of the electronic device shown in FIG. 17B.

### DETAILED DESCRIPTION OF THE INVENTION

Next, embodiments of the present invention will be explained with reference to the drawings hereinafter. The same or like symbols are affixed to the same or like portions in the description in the drawings. In this case, it should be noted that the drawings are schematic drawings.

Embodiments of the present invention explains an electronic device that has a display equipped with a touch panel instead of a mechanical keyboard and can display a virtual keyboard and a pointing device on the display and execute an inputting operation via the display. Here, the virtual keyboard and the pointing device can be switched into various modes in response to either each application software or each user, each version, or the like in the same application software in use.

(Hardware Configuration of Electronic Device)

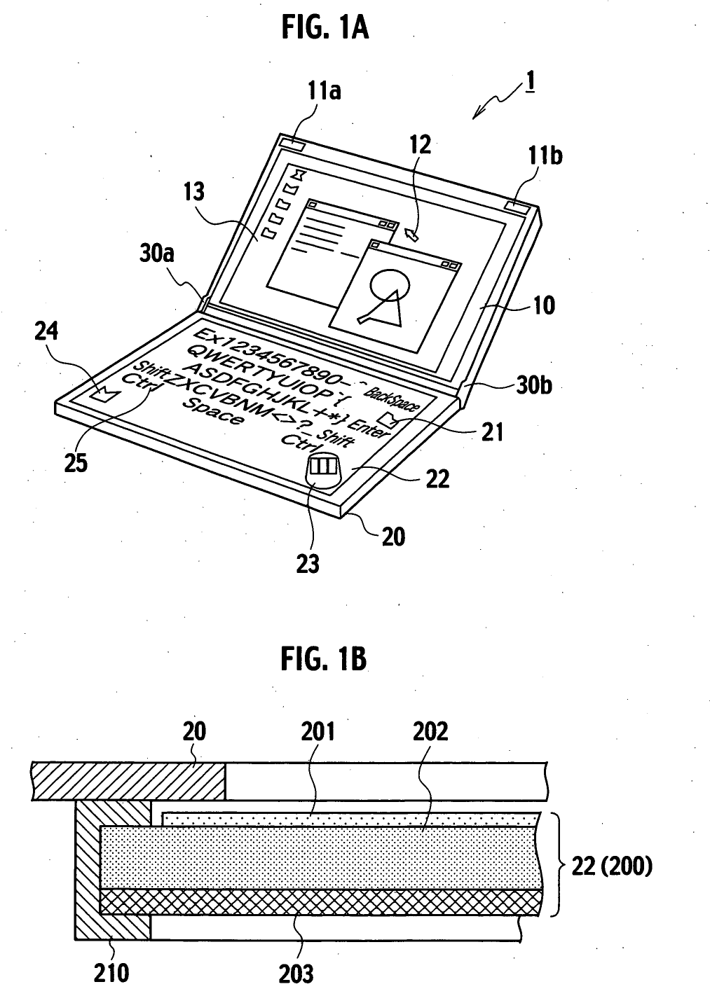

An embodiment of the present invention explains examples in which the present invention is applied to the notebook PC. An electronic device (notebook PC) 1 according to the present embodiment, as shown in FIG. 1A, includes a second enclosure 10 and a first enclosure 20 jointed swingably by hinges 30a, 30b. As shown in FIG. 1B, the first enclosure 20 has an LCD panel 22 (display unit 200 with an input device) having a pressure sensitive function. The LCD panel 22 is a unit that includes a first display device (LCD portion) 202 in which the liquid crystal is sealed between two sheets of glass substrates, an input device (touch panel) 201 fitted onto a surface of the first display device 202, and a backlight 203 fitted onto a back surface of the first display device 202. The LCD panel 22 is held in a metal frame 210 fitted on an inner wall of the first enclosure 20. Meanwhile, an LCD panel 13 is fitted to the first enclosure 20. In the present embodiment, the LCD panel 13 has the almost same configuration as the LCD panel 22 shown in FIG. 1B, although not shown, and does not have only the input device 201.

The electronic device 1 can be used by putting the first enclosure 20 on the desk, for example, and then adjusting appropriately an angle of the hinges 30a, 30b such that the user is easy to see the LCD panel 13 of the second enclosure 10. Since the first enclosure 20 is made of resin, metal, or the like whose thickness can be reduced, the surface of the LCD panel 22 with a touch panel and an upper surface of the first enclosure 20 can be set at an almost same level. Thus, a measure is taken not to cause the user to feel a level difference between both surfaces.

Rubber pads 11a, 11b are provided on the second enclosure 10 side to prevent the collision of the LCD panels 13, 22 when the second enclosure 10 and the first enclosure 20 are closed. In addition to the LCD panel 13, an antenna used in a radio communication such as radio LAN, Bluetooth, or the like, a radio signal transmitting/receiving circuit, a radio signal processing circuit, etc. are built in the second enclosure 10.

Also, in addition to the LCD panel 22, key hardwares such as mother board packaging CPU, RAM, ROM, etc. thereon, HDD, and the like constituting the notebook PC are built in the first enclosure 20. Also, a cable (not shown) is provided near the center of shafts of the hinges 30a, 30b. Power supply and information (signal) exchange are carried out between the second enclosure 10 and the first enclosure 20 via the cable.

As shown in FIG. 1A, an image of the keyboard, i.e., a virtual keyboard 25 is displayed on the LCD panel 22 with the touch panel. An inputting operation of the input device (touch panel) 201 is carried out by pressing the virtual keyboard 25 in the same way as the keys of the normal mechanical keyboard, while the user judges a relationship between a corresponding display screen and the virtual keyboard. At this time, a position being pressed on the display screen of the virtual keyboard 25 is replaced (emulated) with information such as codes, etc. to correspond to the concerned key of the mechanical keyboard, and then the replaced information are transmitted to the operating system (software) of the electronic device 1. Such emulation function of the mechanical keyboard may be installed into an electronic circuit, which controls directly the LCD panel 22 with the touch panel, as the hardware, or may be implemented by the software such as firmware, or the like. Also, the bit-map image formed by the user may be employed as the image of the virtual keyboard 25. Also, as described later, the LCD panel 22 with the touch panel may be employed as the interface in the form other than the keyboard.

Also, the user can change appropriately a plurality of keys displayed as the virtual keyboard 25 on the image, e.g., functions assigned to function keys and image displays. For example, the shortcut icon used to start the application software, etc. can be assigned to the keys as they are. Also, the user can switch the keyboard corresponding to different districts and languages, e.g., the language keyboard such as Japanese keyboard, English keyboard, other language keyboard, Japanese syllabary keyboard, and the like, without change of the hardware in use. Also, it is possible to realize the keyboard arrangement to fit to the user's liking or the started application software, e.g., the presence or absence of the ten key, whether or not the control key and the shift key should be arranged on both left and right sides, whether or not the line feed key should have a longitudinal or lateral shape, the presence or absence of the function keys, etc.

(System Configuration of Electronic Device)

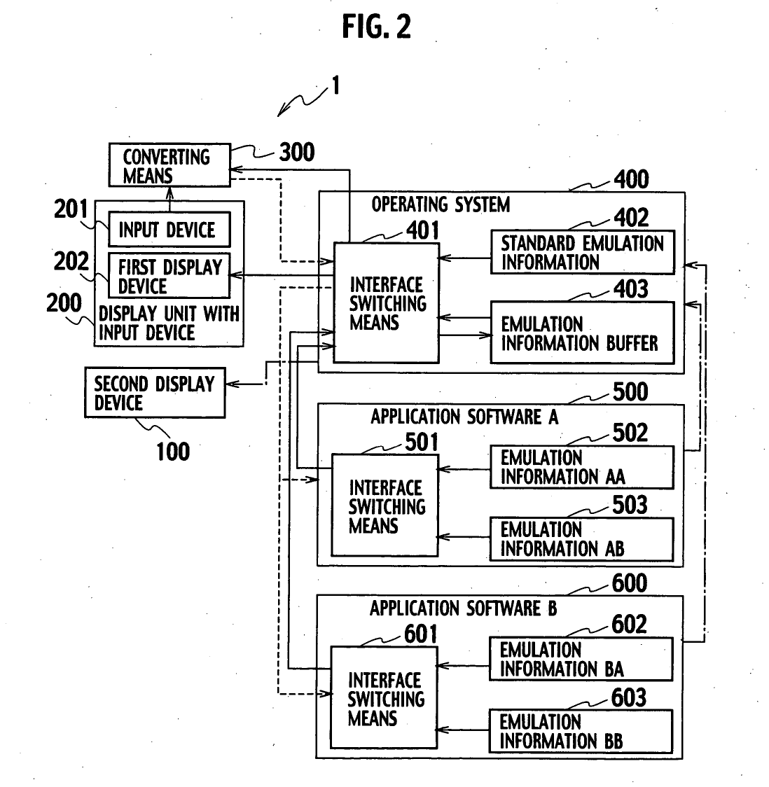

Next, a system configuration of the above electronic device 1 will be explained hereunder. As shown in FIG. 2, the electronic device includes the display unit 200 with the input device having the input device 201 and the first display device 202, a second display device 100, and a converting means 300. This electronic device can start an application software A 500 and an application software B 600 on an operating system (OS) 400.

The second display device 100 is the LCD panel 13 built in the second enclosure 10, as shown in FIG. 1A. The display unit 200 with the input device is the LCD panel 22 built in the first enclosure 20, as shown in FIG. 1A. The input device 201 of the display unit 200 with the input device is the touch panel shown in FIG. 1B, and the first display device 202 is the LCD portion shown in FIG. 1B.

The input device 201 is arranged near the first display device 202 (in the present embodiment, pasted directly onto a surface of the first display device 202), and can acquire position information of a touching object. Here, the touching object is a device for inputting the information, for example, user's finger or palm, tool such as a stylus pen, or the like. In the present embodiment, a pressure sensitive touch panel is employed as the input device 201. In this case, the input device 201 is not limited to the pressure sensitive touch panel, but an electromagnetic touch panel or an optical touch panel may be employed as the input device 201. In the electromagnetic touch panel, the user can input the information by the same operation as the pressure sensitive touch panel after the device such as the stylus for the electromagnetic touch panel, or the like is fitted onto the user's finger. Also, a sensor such as an optical sensor, an image sensor, or the like for acquiring the position information may be employed as the input device 201.

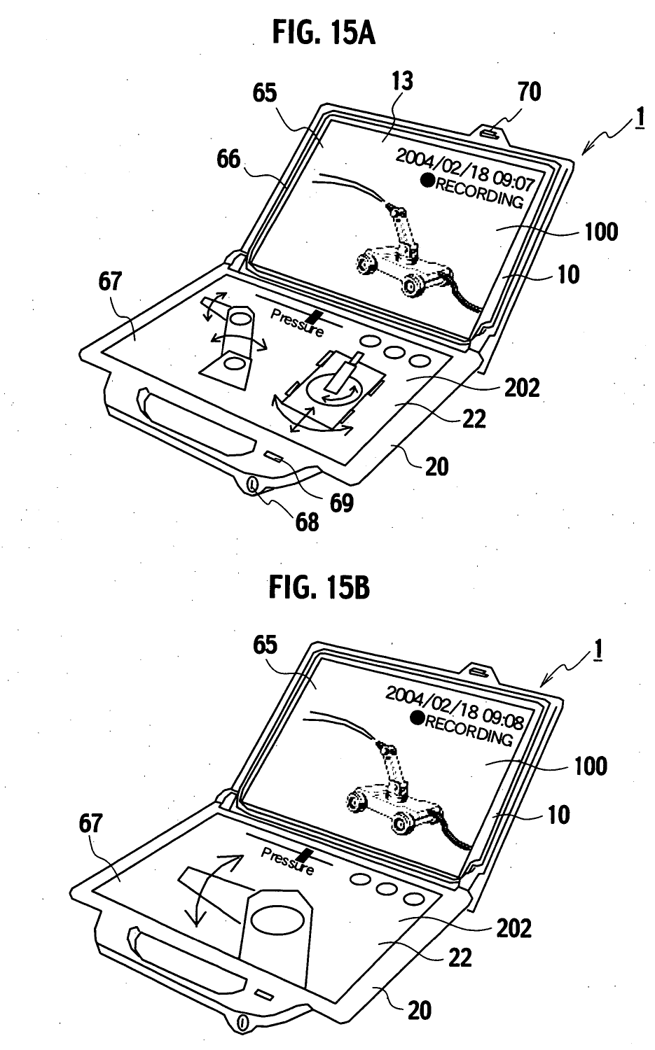

The first display device 202 displays the operating device such as the virtual keyboard 25, and the like as the image. Processed results based on the operations of the operating devices are displayed on the second display device 100 as the images such as characters, symbols, videos, and the like. Also, not only the images created based on the operating devices but also the actual images picked up the imaging device such as the camera, the sensor, or the like, as shown in FIG. 15, are displayed on the second display device 100. In the present embodiment, the liquid crystal display (LCD) panel is employed as the second display device 100 and the first display device 202. In this case, in place of the liquid crystal display panel, the light emitting diode (LED) panel, the electroluminescence (EL) panel, the surface-conduction electron-emitter display (SED) panel, or the like may be employed as the second display device 100 and the first display device 202.

Also, as the display unit 200 with the input device, the panel having both an image displaying function and a scanner function at the same time by incorporating an optical sensor element array as the input device 201 into the first display device 202 can be employed. Since the user's finger touching the surface of the panel can be sensed as the image and its position information can be acquired, such display unit 200 with the input device can provide the similar operability to the pressure sensitive touch panel. For this type panel having both the image displaying function and the scanner function, for example, “Input Display” is announced on April 2003 from Toshiba-Matsushita Display Technology Co., Ltd. In addition, when this type panel is employed, the user can read the image information such as characters, symbols, photos, and the like printed on the bar code, the name card, etc. from the input device 201 and then the user can recognize the contents based on the image information.

In compliance with emulation information received from an interface switching means 401 of the operating system 400, the converting means 300 converts the information being input to the operating device, which is displayed virtually on the first display device 202, from the input device 201 as if such information is input to the existing operating device. Also, the converting means 300 outputs the converted information to the interface switching means 401.

More particularly, in case the image of the operating device displayed virtually on the first display device 202 corresponds to the keyboard, it is interpreted that the corresponding position of the input device 201 is pressed when the user presses one key of this virtual keyboard. Thus, the converting means 300 converts (code-converts) the information being input from the input device 201 into the signal that is output when one key of the existing keyboard is pressed. This converted signal corresponds to the signal that is handled in the operating system 400, and thus this signal is transmitted to the interface switching means 401.

Also, in case the image of the operating device displayed virtually on the first display device 202 corresponds to the mouse (pointing device), it is interpreted that the corresponding position of the input device 201 is moved when this virtual mouse is moved. Thus, the converting means 300 converts the information being input from the input device 201 into the signal that is output when the existing mouse is moved. Similarly, this converted signal corresponds to the signal that is handled in the operating system 400, and thus this signal is transmitted to the interface switching means 401 of the operating system 400.

The operating system 400 has one emulation information or more corresponding to the normal keyboard, mouse, stick, and the like. Standard one out of the emulation information is set as standard emulation information (initial emulation information) 402. At least following information are contained in the emulation information. That is, ID number information, virtual interface image information displayed on the display unit 200 the with input device (image information of the operating device such as the keyboard, the mouse, or the like), key code correspondence information showing a relationship between a position of the image that the user touches and the character, the symbol, or the like being output corresponding to the position, and correspondence information between touch sensing information indicating how the user touches a surface of the touch pad with the finger to operate the pointing device, and the like and the operation of the pointing device. In other words, the images of the virtual operating devices, and information about correspondences between position information being input from the input device 201 and output information output when the position information are input from the input device 201 are contained in the emulation information.

Also, the operating system 400 further includes the interface switching means 401 and an emulation information buffer 403.

The interface switching means 401 transmits any one of the standard emulation information 402, emulation information saved in the emulation information buffer 403 or emulation information AA, AB 502, 503 received from an interface switching means 501 of an application software A 500, or emulation information BA, BB 602, 603 received from an interface switching means 601 of an application software B 600 to the converting means 300. Also, the interface switching means 401 transmits interface image information (operating device image information) to the first display device 202. Also, the interface switching means 401 transmits the converted information received from the converting means 300 to the application software A, B 500, 600.

In this event, the interface switching means 401 may be realized as a function of the operating system 400 as illustrated, or may be inserted into information routes connecting the operating system 400 and the keyboard and the pointing device as additional software. Also, the interface switching means 401 may be incorporated into BIOS.

The emulation information buffer 403 stores temporarily the emulation information used in the past. The emulation information buffer 403 may store all the emulation information, or may store a part of the emulation information.

Like the operating system 400, the application software A 500 and the application software B 600 have at least one of the emulation information AA, AB 502, 503 and the emulation information BA, BB 602, 603, which are fitted to the operation, respectively. The application software A 500 has a plurality of emulation information AA, AB 502, 503. Then, it is decided which one of the emulation information AA, AB 502, 503 should be employed, in response to the processing situation of the application software A 500. Similarly, the application software B 600 has a plurality of emulation information BA, BB 602, 603. Then, it is decided which one of the emulation information BA, BB 602, 603 should be employed, in response to the processing situation of the application software B 600.

In FIG. 2, the interface switching means 501 of the application software A 500 transmits any one emulation information out of a plurality of emulation information (the emulation information AA 502 and the emulation information AB 503) to the interface switching means 401 of the operating system 400. Similarly, the interface switching means 601 of the application software B 600 transmits any one emulation information out of a plurality of emulation information (the emulation information BA 602 and the emulation information BB 603) to the interface switching means 401 of the operating system 400.

Also, the screen output information transmitted from the application software A 500 and the application software B 600 are transmitted to the second display device 100 via the operating system 400.

The user of the electronic device 1 can change arbitrarily the emulation information of the application software A 500 and the application software B 600. Also, the user can designate which information among a plurality of emulation information should be set as the standard emulation information.

Here, in case application software not including the emulation information is employed, the user can utilize the standard emulation information 402 that the operating system 400 prepares as the default. That is, the application software developed for use in the notebook PC equipped with the mechanical keyboard can also be operated in the electronic device (notebook PC) according to the present embodiment.

(Second System Configuration of Electronic Device)

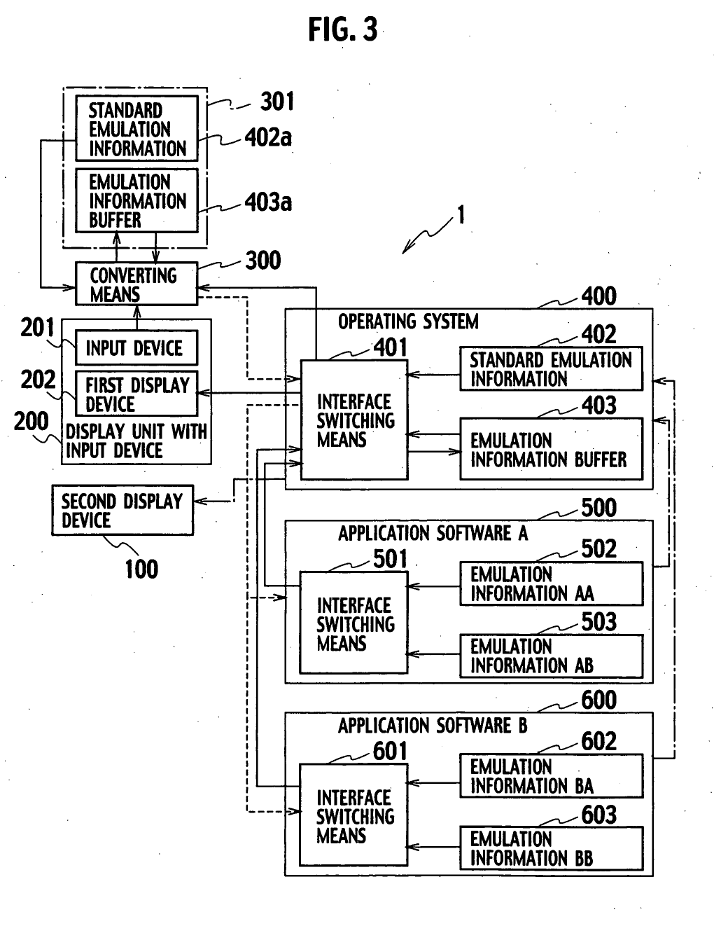

Next, as a second system configuration of the electronic device, the case where the standard emulation information and the emulation information buffer are constructed by using the hardware connected directly to the converting means 300 will be explained with reference to FIG. 3 hereunder.

Here, the converting means 300 is formed as a dedicated hardware, and an emulation information buffer 403a and a read-only standard emulation information 402a are stored in an inside of a memory device 301. That is, the emulation information buffer 403a and the read-only standard emulation information 402a are stored in a memory area of the memory device 301. In this second system configuration, even though the operating system 400 that corresponds to the display unit 200 with the input device is not installed, the converting means 300 can convert the signal received from the input device 201.

The memory device 301 for storing the converting means 300, the emulation information buffer 403a, and the standard emulation information 402a therein may be loaded on one semiconductor chip, or it may be loaded separately on a plurality of semiconductor chips.

(Third System Configuration of Electronic Device)

Next, the case where most of the hardwares in the electronic device 1 such as the converting means 300, the interface switching means 401, 501, 601, etc. are implemented by the software will be explained hereunder.

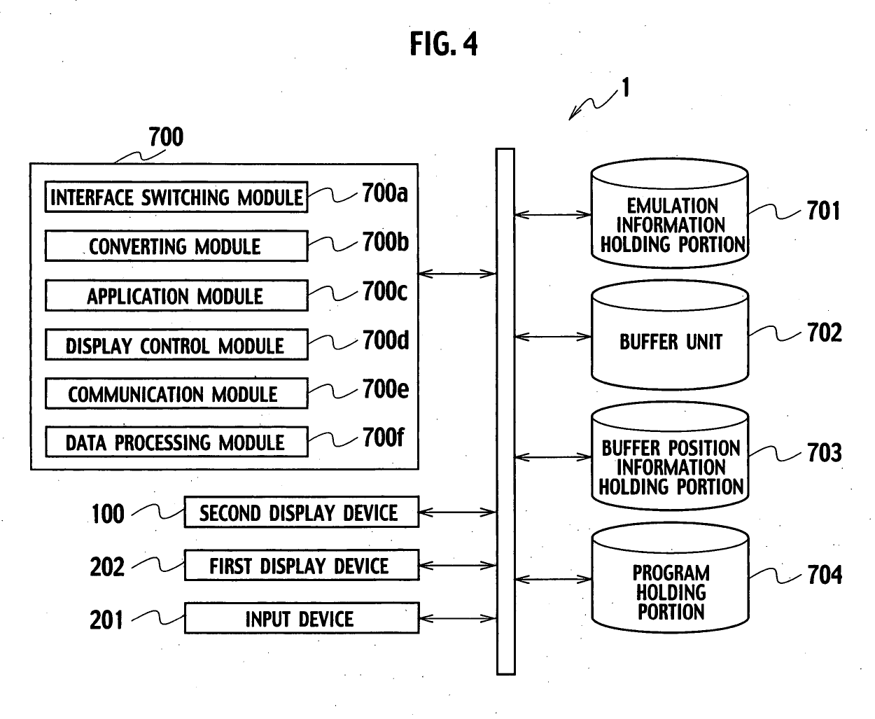

As shown in FIG. 4, the electronic device 1 includes a central processing unit (CPU) 700. Then, an interface switching module 700a, a converting module 700b, an application module 700c, a display control module 700d, a communication module 700e, and a data processing module 700f are built in this CPU 700. These modules can be constructed by executing dedicated programs used in the general-purpose computer such as the PC, or the like to utilize the programming language.

A function of the interface switching module 700a is similar to the function of the foregoing interface switching means 401, 501, 601, and therefore an explanation thereof will be omitted herein. Also, a function of the converting module 700b is similar to the function of the foregoing converting means 300, and therefore an explanation thereof will be omitted herein.

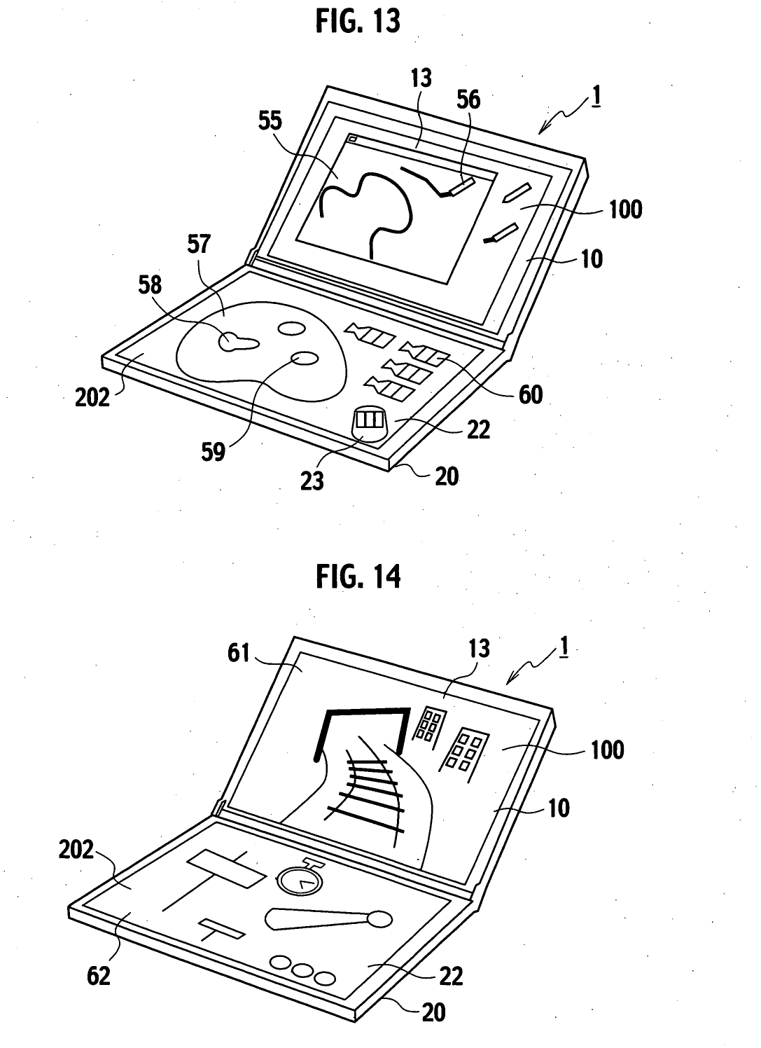

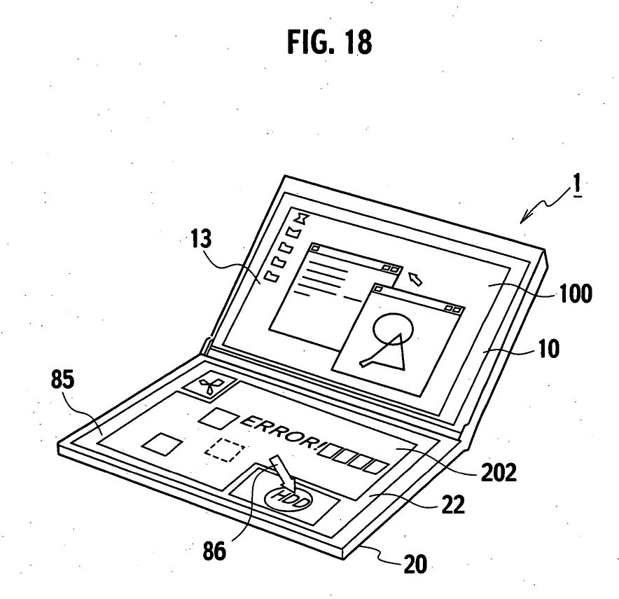

The application module 700c executes various application softwares. The display control module (display controlling means) 700d displays the image of the virtual operating device on the first display device 202, and also displays output data after such operating device is operated on the second display device 100. Also, the display control module 700d changes a display mode of the operating device displayed on the first display device 202, in response to the position information of the input device 201. For example, in the electronic device 1 shown in FIG. 10, a virtual keyboard 42 is displayed on the first display device 202, and then the user can change a color of the portion, to which the user touches his or her finger, of the keyboard 42. Also, in the electronic device 1 shown in FIG. 14, a virtual game interface screen 62 is displayed on the first display device 202, and then the user can change a position of the image displayed on the second display device 100 in answer to a location, that the user touches with his or her finger, of the operating lever on this game interface screen 62. Also, as shown in FIG. 18, the display control module 700d displays a position of the hardware parts in a position, which corresponds to the position information, of the first display device 202 by looking up position information in a hardware position information holding portion 703.

The communication module (communicating means) 700e transmits the information converted by the converting module 700b to the outside of the electronic device 1, and receives the information from the outside to the inside of the electronic device 1. Concretely, the communication module 700e controls an antenna for the radio communication such as a radio LAN, Bluetooth, and the like, and a communication device such as a wire LAN, IEEE 1394, USB, telephone line, and the like. For example, in the electronic device 1 shown in FIG. 15, an image 65 picked up by a camera, which is fitted to an automated fire-fighting engine equipped with a fire-extinguishing equipment, is shown on the second display device 100, and also an operation interface screen 67 is displayed on the first display device 202. In this case, the communication module 700e transmits the operation signal acquired from the input device 201 to the automated fire-fighting engine. Also, the communication module 700e receives the information such as outputs of the sensors fitted to the automated fire-fighting engine to measure a temperature, a distortion, a torque, etc., an mount of energy consumption such as a power consumption of a power unit of the automated fire-fighting engine, a power consumption of an illumination unit, etc., physical properties applied to a mechanism unit of the automated fire-fighting engine, and others.

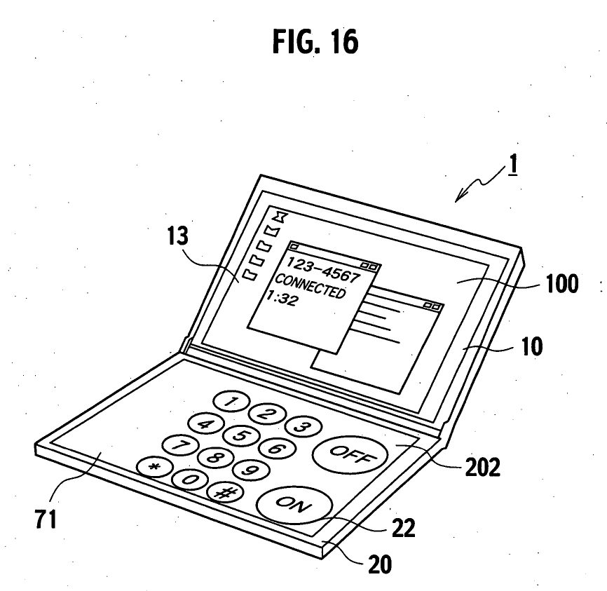

Also, in the electronic device 1 shown in FIG. 16, a phone interface screen 71 is displayed on the first display device 202, and the phone number that the user inputs is displayed on the second display device 100. When the input device 201 acquires the information of the phone number after the user inputs the phone number, the electronic device 1 connects the telephone line to the phone having the concerned phone number via the communication module 700e.

The data processing module (data processing means) 700f executes the data processing in regarding to the hardware parts, based on the signal converted by the converting module 700b. For example, in the case where peripheral equipments are connected to the electronic device 1, the data processing module 700f executes the processing of the data remaining in the cache and the disconnecting process of the peripheral equipments, based on the information acquired from the input device 201. Here, the term “peripheral equipment” means the external electronic device connected to a connector or a card slot of the electronic device 1 except the electronic device 1. A printer, a scanner, an external HDD, a detachable built-in HDD, a memory card, a magnetic disk device, an optical disk device, etc. correspond to such peripheral equipment.

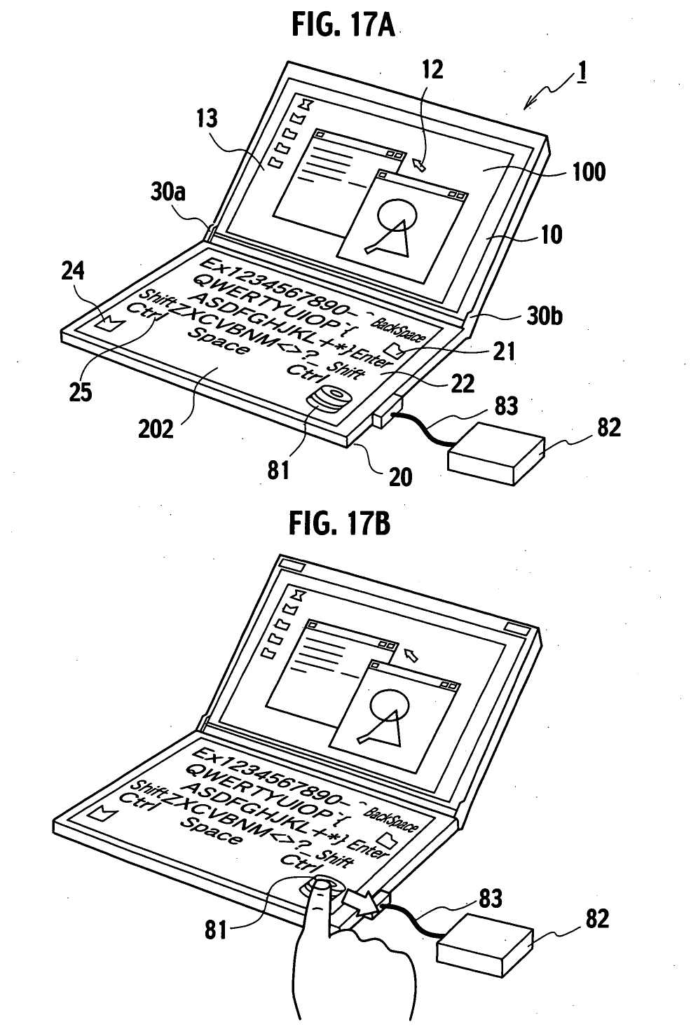

For example, in the electronic device 1 shown in FIG. 17A, an external HDD 82 is connected to the connector or card slot (not shown) of the first enclosure 20 via a cable 83, and an HDD icon 81 is displayed on the first display device 202. In this case, as shown in FIG. 17B, when the user touches the HDD icon 81 with his or her finger and moves the finger as it is in the direction to pull out the connector, i.e., slides the finger from the left side to the right side of the first enclosure 20, the data processing module 700f saves the information kept temporarily in the cache or the RAM in the external HDD 82 and then executes the disconnecting process of the external HDD 82.

Also, as shown in FIG. 4, an emulation information holding portion 701, a buffer 702, a hardware position information holding portion 703, and a program holding portion 704 are connected to the CPU 700 via a data bus respectively.

The emulation information holding portion 701 holds the images of the operating devices to be displayed on the first display device 202, and the emulation information in which correspondences between position information input from the input device 201 and output information output based on the position information input from the input device 201 are described. The standard emulation information 402 of the operating system 400, the emulation information AA, AB 502, 503 of the application software A 500, and the emulation information BA, BB 602, 603 of the application software B 600 are contained in the emulation information.

The emulation information used in the past are stored temporarily in the buffer 702. In the present embodiment, the buffer 702 is constructed by a memory that stores exclusively only such emulation information. Also, the buffer 702 can be constructed in a main memory of the electronic device 1 or a part of areas of the built-in HDD (or external HDD). If a sufficient empty area (capacity) does not remain in the main memory of the electronic device 1 or the built-in HDD, an available empty area can be used as the buffer 702 and not all emulation information but a part of the emulation information can be stored in this buffer 702.

The hardware position information holding portion 703 holds the position information of the hardware parts built in or connected to the electric unit 1. As in the electric unit 1 shown in FIG. 18, for example, the user can display a screen 85, which shows arrangement positions of the hardware parts, on the first display device 202 by referring to the position information.

In this case, the emulation information holding portion 701 and the hardware position information holding portion 703 are recording media used to save the information. As the recording medium, for example, a nonvolatile memory such as RAM, ROM, flash memory (EEPROM), etc., a magnetic disk such as hard disk, flexible disk, etc., an optical disk such as compact disk, etc., an IC chip, a magnetic tape, and the like can be practically used. Because such recording medium is employed, the user can easily save, carry, sale, or the like the information.

The program holding portion 704 saves a control program that causes the CPU 700 to execute the information processing such as the interface switching process, the converting process, and others. When the user causes to execute this control program, the user can carry out various functions of the interface switching module 700a, the converting module 700b, the application module 700c, the display control module 700d, the communication module 700e, and the data processing module 700f and thus carry out the information processing in the electronic device 1. The recording medium such as RAM, ROM, HDD, flexible disk, compact disk, IC chip, magnetic tape, or the like, for example, can be practically used as the program holding portion 704. Because such recording medium is employed, the user can easily save, carry, sale, or the like the control program.

Now, the interface switching module (interface switching means) 700a, the converting module (converting means) 700b, the display control module (display controlling means) 700d, the communication module (communicating means) 700e, and the data processing module (data processing means) 700f are not limited to the modules that are constructed by the software that is executed by the CPU 700. But these modules may be constructed by the hardware. Also, the CPU 700 is not limited to the CPU that is packaged only on the motherboard being built in the electronic device 1. But such CPU may be packaged as a chip set on the board on which an element for controlling the memory or the peripheral equipment is packaged.

(Control Method of Electronic Device)

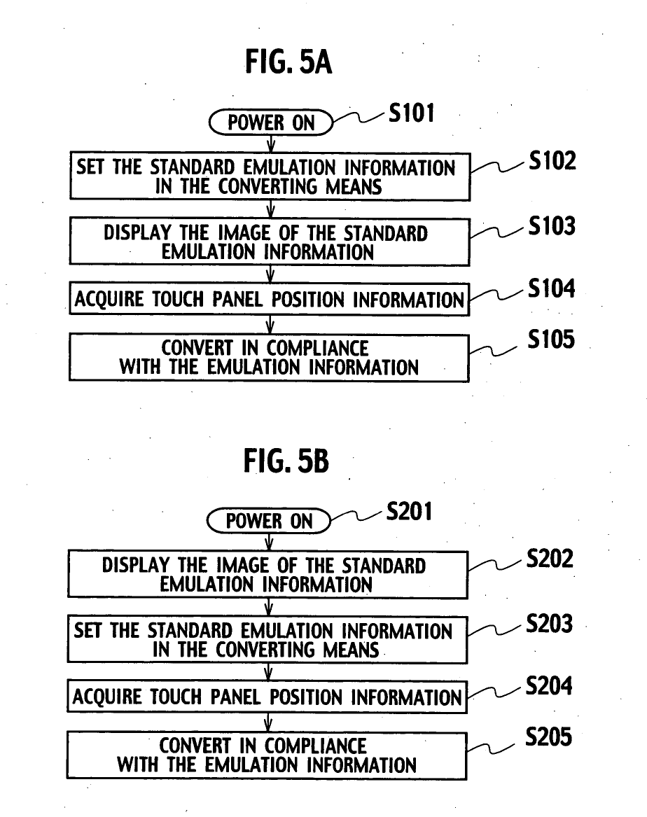

Next, an operation in starting the electronic device 1 will be explained with reference to FIGS. 5A and 5B while also referring to FIG. 2 hereunder.

First, in step S101 shown in FIG. 5A, a power supply of the electronic device 1 is turned on. Then, in step S102, the standard emulation information 402 for initialization contained in the operating system 400 is loaded into the converting means 300 and then the initialization is executed in the converting means 300. Then, in step S103, the image of the operating device such as the virtual keyboard, or the like described in the standard emulation information is displayed on the first display device 202. Then, the converting means 300 starts the conversion from the input to the input device (touch panel) 201 to the key code, or the like. That is, as shown in step S104, when the user touches his or her finger to the input device (touch panel) 201, position information of the touched location is acquired. Then, as shown in step S105, the position information input from the input device (touch panel) 201 is converted into output information of the operating device in compliance with the emulation information 402.

In contrast, the operation in starting the electronic device 1 may be executed according to the procedures shown in FIG. 5B. In step S201 shown in FIG. 5B, the power supply of the electronic device 1 is turned on. First, in step S202, the interface image such as the keyboard, or the like described in the standard emulation information is displayed on the first display device 202. Then, in step S203, the standard emulation information 402 for initialization contained in the operating system 400 is loaded into the converting means 300 and then the initialization is executed in the converting means 300. Then, the converting means 300 starts the conversion from the input to the input device (touch panel) 201 to the key code, or the like. Since step S204 and step S205 are similar to above step S104 and step S105, their explanation will be omitted herein.

According to the operation procedures of the electronic device 1 shown in FIG. 5A, the loading of the emulation information into the converting means 300 has already been ended the moment the image of the virtual operating device based on the emulation information is displayed on the first display device 202. Therefore, a time period required from the display of the operating device to a start of the user's inputting operation is short. However, if it is used as a trigger for a start of the touch panel input conversion that the emulation information is loaded into the converting means 300, in some cases the wrong instruction is input into the first display device 202 on which no image is displayed. In order to avoid such wrong input, the instruction to start the conversion is given to the converting means 300 from the operating system 400, or the converting means 300 is caused to stand by until the conversion is started.

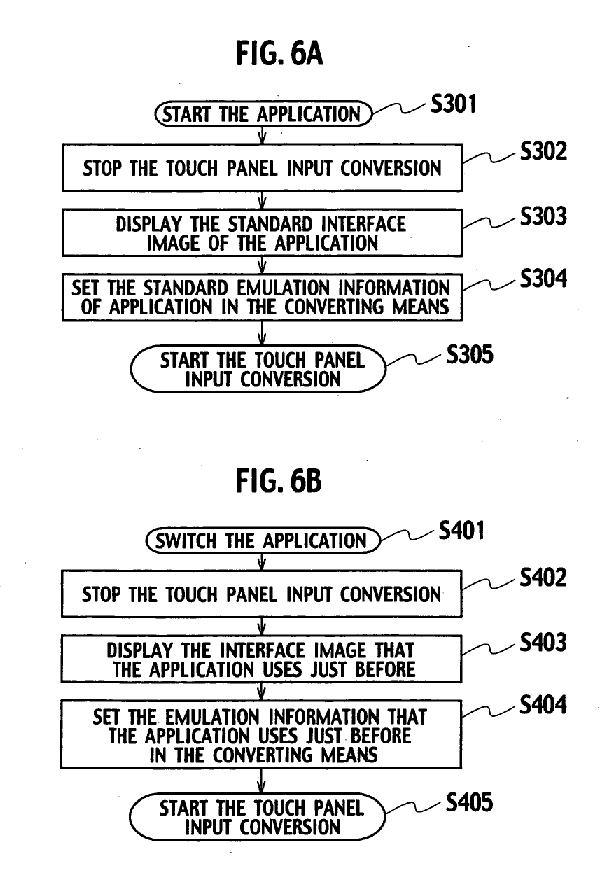

On the contrary, according to the operation procedures of the electronic device 1 shown in FIG. 5A, even when the conversion of the touch panel input is started immediately after the converting means 300 accepts the emulation information, the wrong instruction is never input into the first display device 202 on which no image is displayed. Next, an operation in the electronic device 1 executed after the application software is started will be explained with reference to FIG. 6A while also referring to FIG. 2 hereunder.

First, in step S301 shown in FIG. 6A, the application software A 500 (or the application software B 600) is started. Then, in step S302, the converting means 300 stops the conversion from the input device 201 (touch panel) input to the key code, or the like. Then, in step S303, the standard interface image used in the application software is displayed on the first display device 202, based on the standard emulation information 402 in the operating system 400. Subsequently, in step S304, the emulation information AA 502, for example, instructed in the application software A 500 is loaded into the converting means 300, and the setting is executed in the converting means 300 based on the emulation information AA 502. Then, in step S305, the converting means 300 starts the converting operation of the touch panel input again. Input information into the touch panel is converted in the converting means 300, and then this converted information is output to the application software A 500. The screen display of the operating device used in the application software A 500 on the first display device 202 may be executed at any timing until the input conversion to the touch panel is started once again after such input conversion is stopped. That is, step S303 and step S304 may be executed in reverse order.

Next, an operation taken when the application is switched from the application software A 500 to the application software B 600 in the condition that plural application softwares A, B 500, 600 are being started will be explained with reference to FIG. 6B while also referring to FIG. 2 hereunder. First, in step S401 shown in FIG. 6B, the application software A 500 is switched to the application software B 600. Then, in step S402, the converting means 300 stops the conversion of the input into the input device 201 (touch panel) to the key code, or the like. Then, in step S403, the latest interface image used in the past in the application software B 600 after the switching is read from the emulation information buffer 403 of the operating system 400, and is displayed on the first display device 202. That is, the interface screen of the input environment when the application software B 600 after the switching was being used lastly by the user is displayed on the first display device 202. Then, in step S404, the emulation information 602, for example, that the application software B 600 after the switching used just before is loaded in the converting means 300, and then the setting based on the emulation information 602 is carried out in the converting means 300. Then, in step S405, the converting means 300 starts the converting operation of the touch panel input again, and thus the input information into the touch panel is converted in the converting means 300. Then, this converted information is output to the application software B 600.

Here, the screen display of the operating device used in the application software B 600 on the first display device 202 may be carried out at any timing until the conversion of the input into the touch panel is started once again after such conversion is stopped. That is, step S403 and step S404 may be executed in reverse order.

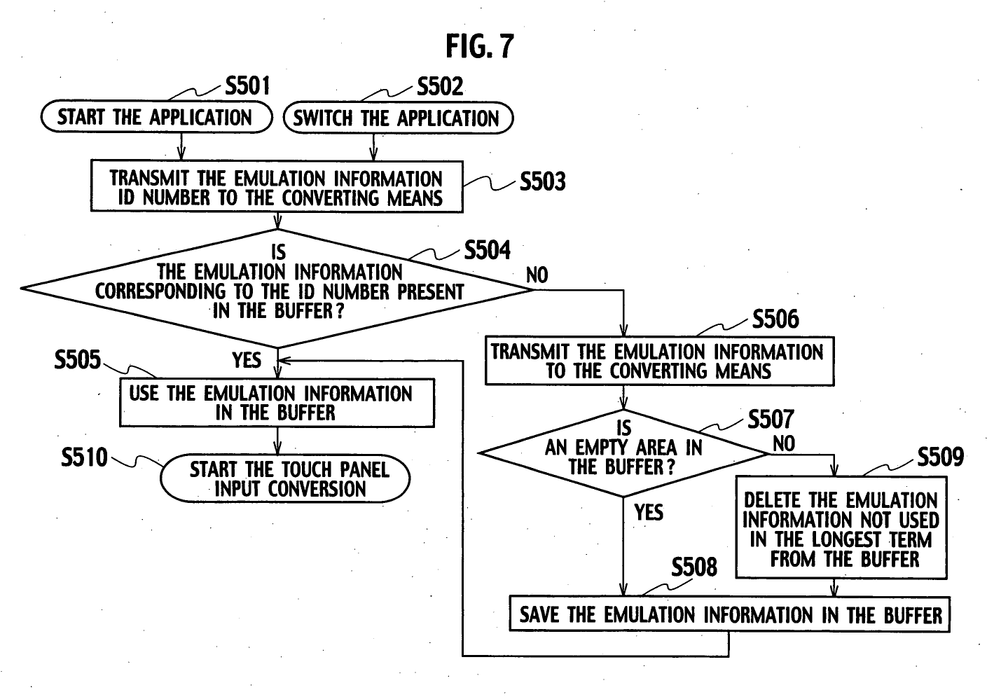

Next, an operation of acquiring the emulation information from the emulation information buffer 403a in the starting or switching operation of the application software A 500 or the application software B 600 will be explained with reference to FIG. 7 hereunder. Here, the switching of the emulation information is executed automatically by the operating system 400 in response to the operation situation of the application software A 500, the application software B 600, or the peripheral equipments. Also, the switching of the emulation information may be executed in answer to the user's request. In this case, the electronic device 1 shown in FIG. 3 is used herein and the emulation information stored in the emulation information buffer 403a is loaded directly into the converting means 300.

First, when the application software A 500 is started (step S501), such application software A 500 transmits the identification number of the emulation information AA 502 (or the emulation information AB 503) to the converting means 300 via the operating system 400 in step S503. Also, when the switching operation from the application software A 500 to the application software B 600 is executed (step S502), such application software B 600 transmits the identification number of the emulation information to the converting means 300 via the operating system 400 in step S503. Where the term “identification number” denotes the number assigned uniquely to each emulation information to identify the emulation information.

In step S504, the converting means 300 decides whether or not the emulation information corresponding to the identification number is contained in the emulation information buffer 403a. If it is decided that the emulation information corresponding to the identification number is present in the buffer, the process goes to step S505. Then, the emulation information in the emulation information buffer 403a is used. In contrast, if it is decided that the emulation information corresponding to the identification number is not present in the buffer, the process goes to step S506.

In step S506, the application software A 500 transmits the emulation information AA 502 or the emulation information AB 503 to the converting means via the operating system 400. Then, in step S507, the converting means 300 decides whether or not an empty area is present in the emulation information buffer 403a. If the empty area is present, the process goes to step S508. In contrast, unless the empty area is present, the process goes to step S509. Then, the oldest emulation information in the emulation information buffer 403a, i.e., the emulation information not used in the longest term is deleted from the emulation information buffer 403a to produce the empty area.

In step S508, the newly acquired emulation information AA 502 or emulation information AB 503 is saved in the emulation information buffer 403a. In step S505, the emulation information in the emulation information buffer 403a is used. Then, in step 510, the converting means 300 starts the converting operation of the touch panel input once again, so that the input into the touch panel can be transmitted to the application software A 500.

Here, since the oldest emulation information is searched in step S509, information about a used time of the lastly used emulation information, a used order of the emulation information, etc. are stored in the emulation information buffer 403a, as internal information or external information of the emulation information.

Also, the method of accessing the emulation information buffer 403a by the converting means 300 in compliance with operation procedures shown in FIG. 7 is explained as above. In the electronic device shown in FIG. 2, the similar function can be implemented if the interface switching means 401 of the operating system 400 accesses the emulation information buffer 403.

(Concrete Examples of Emulation Information)

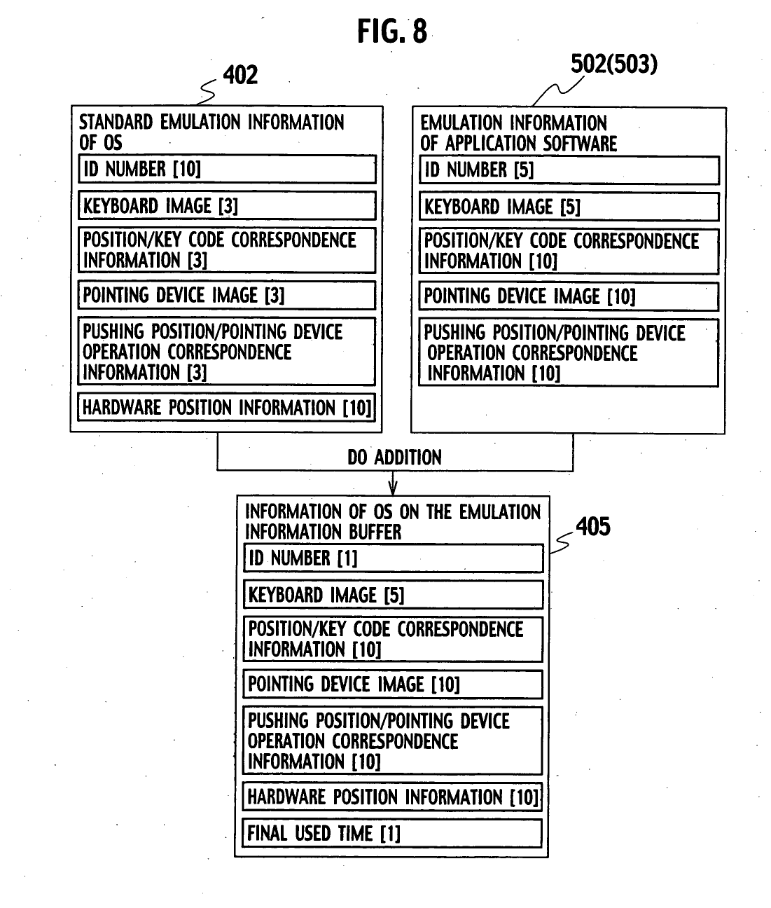

Next, details of above-mentioned emulation information will be explained with reference to FIG. 8 hereunder. The emulation information have the unique identification number respectively, and are a set of plural information such as the image of the operating device (the image of the keyboard or the image of the pointing device), a correspondence between the image of the operating device and the position information of the input device (position/key code correspondence information or pressing position/pointing device operation correspondence information), hardware position information indicating the positions of connectors on the enclosure surface, and the like.

For example, the case where the emulation information AA 502 that the application software A 500 possesses is synthesized with the standard emulation information 402 that the operating system 400 possesses will be explained herein. More concretely, the standard emulation information 402 in the operating system 400 is reproduced on the emulation information buffer 403a in the operating system 400, and then new emulation information 405 is generated by synthesizing the emulation information AA 502 with the information thereon.

At this time, the priority is attached to respective information contained in the standard emulation information 402 and the emulation information AA 502, and the item with the larger numerical value is applied preferentially. That is, upon synthesizing plural pieces of emulation information, the information with the higher priority out of the information to be synthesized is employed preferentially. In FIG. 8, the numerical value given in [ ] denotes the priority.

In the example shown in FIG. 8, the new identification number [1] is assigned to the emulation information 405 obtained by the addition on the emulation information buffer 403a. For instance, the keyboard image has the priority [3] in the standard emulation information 402 of the operating system 400 and has the priority [5] in the application software A 500. Since the higher the priority the higher the numerical value of the priority, the keyboard image in the application software A 500 is used.

In the synthesis of the emulation information, in addition to doing the addition with regard to such priority, it is possible to overwrite the emulation information that the application software A 500 possesses, without regard to the priority. Also, as for the information that the emulation information AA 502 of the application software A 500 does not possess, e.g., the hardware position information, the hardware position information that the standard emulation information 402 of the operating system 400 possesses is used as it is. The hardware position information is not contained in the emulation information AA 502 of the application software A 500 according to the present embodiment and shown in FIG. 8.

Also, the information contained in the emulation information is used or not used in some case. For example, in the application software designed to use not the keyboard but the pointing device, the information that does not use the information of the keyboard image is loaded.

(Concrete Examples of Application Software)

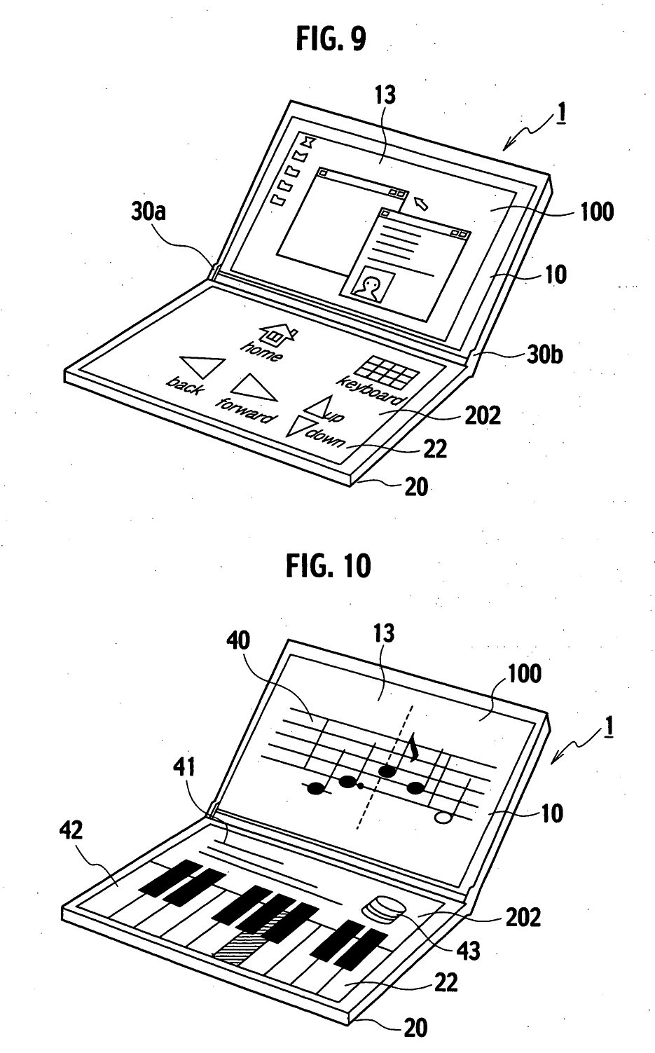

In the above electronic device 1, operational examples of various application softwares will be explained with reference to FIG. 9 to FIG. 16 hereunder. The electronic devices 1 shown in FIG. 9 to FIG. 16 are similar to the electronic device 1 shown in above FIG. 1A, and includes the second enclosure 10 and the first enclosure 20 jointed swingably by hinges 30a, 30b. The LCD panel 22 with the pressure-sensitive touch panel is fitted to the first enclosure 20, and the LCD panel 13 is fitted to the second enclosure 10.

Internet Browser

The electronic device 1 shown in FIG. 9 displays the ideal input interface for the Internet Browser. An icon (back) for displaying the site access history to go back, an icon (forward) for displaying the history to go forward, an icon (up and down) for scrolling the screen up or down in the displayed page, an icon (home) for returning to the home, an icon (keyboard) for displaying the virtual keyboard used in executing the more complicated inputting operation, and the like can be displayed on the LCD panel 22 on the first enclosure 20 side.

Musical Instrument

The electronic device 1 shown in FIG. 10 displays the virtual keyboard 42, a virtual string 41, and a virtual percussion 43 used in the musical instrument such as the piano, etc. on the LCD panel 22 on the first enclosure 20 side. An inputting operation of the musical score can be executed simply by using the music-oriented software together, so that the activity such as the musical composition, or the like can be facilitated. Also, the electronic device 1 can be used as it is as the piano, the organ, the Electone, or the like by using the virtual keyboard 42, while changing a tone color. Here, as described above, the electronic device 1, although not shown, consists of the PC, for example, and has speakers and a microphone as the standard equipment. The musical score (play position indicating cursor) is displayed on the LCD panel 13 on the second enclosure 10 side, and the musical score can be moved from the right to the left on the LCD panel 13 with the progress of the play, for example. A color of the virtual keyboard 42 that the user's finger touches can be changed in response to the touching strength, otherwise a color of the virtual keyboard 42 to be touched next (to be played next) can be changed in display.

Also, the sound can be generated by beating the virtual percussion 43 other than the virtual keyboard 42, or the playing situation of the string instrument can be produced when the user strokes a plurality of virtual strings 41 by the finger (when the user's finger goes across the virtual strings 41 while touching the touch panel). Thus, the musical instrument that cannot be implemented by the mechanical keyboard can be virtually produced.

In the electronic device 1 shown in FIG. 10, the user can input the music data only by touching the touch panel with his or her finger. Therefore, the operation of inputting the music data by clicking the button after the pointer of the pointing device is set on the position of the keyboard displayed on the screen, and then plotting musical notes on a music sheet by the pointing device can be eliminated. Also, in the electronic device 1, the musical notes (music data) can be successively input by the input from the virtual keyboard 42, and also sound lengths of the musical notes can be automatically decided by the input time interval from the virtual keyboard 42. Therefore, an efficiency of the operation of inputting the music data (music composing operation) can be enhanced. In addition, the virtual keyboard 42, the virtual strings 41, and the like can be displayed on the electronic device 1. Therefore, there is no necessity of attaching the external keyboard, the external string instrument, and the like to the electronic device 1, and the electronic device 1 can be constructed as the musical instrument that is suitable for the mobile use. Further, one electronic device 1 can be switched into various musical instruments such as the keyboard, the string instrument, the percussion instrument, and the like in response to the situation. In particular, in the music composing operation of the play using a plurality of instruments, the electronic device 1 is effective in inputting the music data.

The sound strength may be input into the software as the information of a touching strength to the touch panel in a multilevel mode. Since the electronic device 1 according to the present embodiment has a communication function, the play can be performed while using the electronic device 1 by a plurality of players if such players communicate the playing situation mutually via the Internet, or the like.

Editing

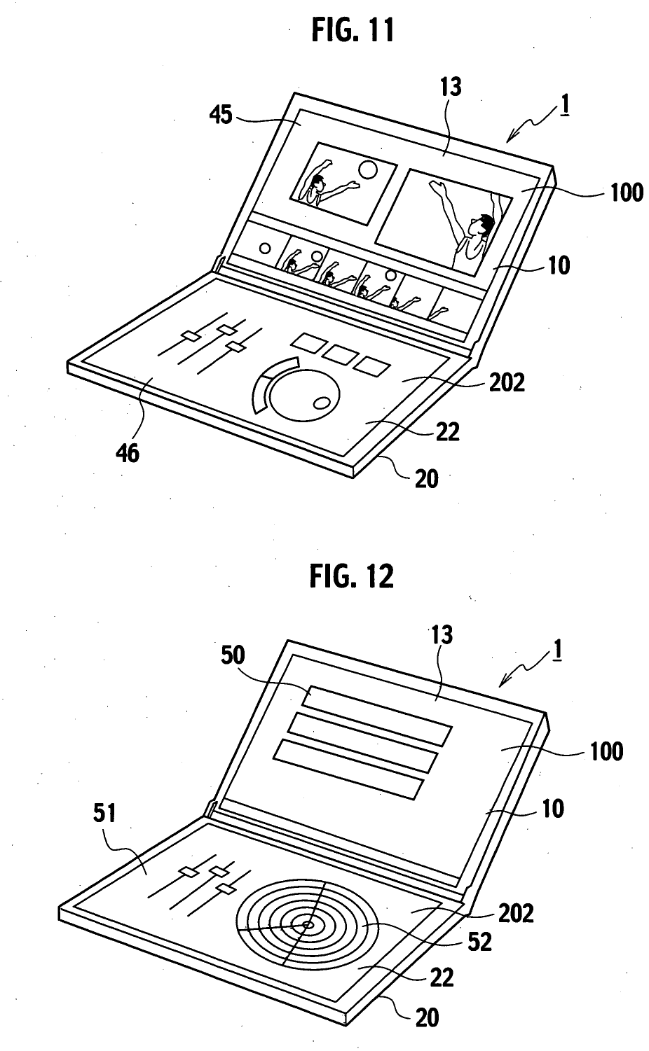

The electronic device 1 shown in FIG. 11, the editing of the moving picture or the sound can be executed simply. The electronic device 1 displays an editing interface screen 46 used to edit the moving picture or the sound on the LCD panel 22 on the first enclosure 20 side, and displays a moving picture editing screen 45 on the LCD panel 13 on the second enclosure 10 side. The operating device such as a jog dial for moving forward or backward the moving picture, a lever for mixing the sound, or the like, which has the same function as the video editing equipment, is displayed on the editing interface screen 46.

DJ

The electronic device 1 shown in FIG. 12, a virtual turntable 52, a virtual mixer 51, and the like are displayed on the LCD panel 22 on the first enclosure 20 side, and music data names 50 are displayed on the LCD panel 13 on the second enclosure 10 side. Then, a composition stored in HDD as digital data can be played by scratching the data. In the electronic device 1, a plurality of music data chosen by the user or chosen by the software at random are allocated to radially partitioned regions of the virtual turntable 52. Respective music data can be scratched by executing such an operation that the user scratches respective regions of the virtual turntable 52 while touching them with the finger. The user can recognize which music data are allocated to respective phase regions, based on respective distances from a center of the virtual turntable 52 and respective phase regions partitioned radially.

One mechanical turntable can respond to one music piece only. In contrast, in the electronic device 1 shown in FIG. 12, a plurality of music pieces are allocated to one virtual turntable 52 as the music data, and a plurality of music pieces can be output at a time. For example, if the user handles the virtual turntable 52 of the electronic device 1 with a plurality of fingers of one hand, a plurality of music pieces can be output at a time not to use both hands. The number of the mechanical turntables that can be operated by one user is two, and one user can implement only two scratches. However, in the electronic device 1 according to the present embodiment, the user can implement three scratches or more.

Painting

The electronic device 1 shown in FIG. 13 can handle the painting. In the electronic device 1, images of a virtual palette 57 and a virtual paint 60 are displayed on the LCD panel 22 on the first enclosure 20 side, and a drawing area 55 is displayed on the LCD panel 13 on the second enclosure 10 side. When the user chooses the paint by touching the image of the virtual paint 60 with his or her finger, such a situation is displayed that a predetermined amount of virtual paint 60 is put on the location of the virtual palette 57 that the user touches with the finger. Also, the user can mixes the colors by stroking plural virtual paints 58, 59 having different colors with the finger, and also the user can change a degree of color mixture in response to the place and time where and when the virtual paints are mixed on the virtual palette 57. For example, if the user chooses red and blue virtual colors 60 and mixes all the red paint on the virtual palette 57 and a part of blue paint in a short time, such user can produce a purple paint that gets tinged with red as a whole but has still red and blue primary colors like a speckled pattern. When the user chooses this paint and draw a line, such user can draw a reddish purple line in which the red and blue are mixed in places like a stripe along the drawing direction. In drawing the line, the user can choose various types of drawing tools such as brush, compass, spray, etc. A pointer 56 corresponding to the chosen drawing tool is displayed on the LCD panel 13 on the second enclosure 10 side. The pointer 56 give the brush image when the user chooses the brush, and a top end of the brush image is changed to the chosen paint color.

Game

The electronic device 1 shown in FIG. 14 displays a game interface screen on which the running simulation of the electric train is selected as a theme. In the electronic device 1, a game screen 61 showing the scenery when viewed from the train driver of the electric train is displayed on the LCD panel 13 on the second enclosure 10 side, and the game interface screen 62 from which analogue input operations required for the game can be applied is displayed on the LCD panel 22 on the first enclosure 20 side. When the user touches this game interface screen 62 with his or her finger or moves the touch position while touching his or her finger, or the like to the game interface screen 62, such user can operate various displayed levers, and the like.

The electronic device 1 shown in FIG. 14 is not limited to the case where the game interface associated with the running of the electric train is displayed. Such electronic device 1 can also be used in the case where the interface of the game such as the flight simulation, the robot operation, or the like is displayed. In either case, since the interface image corresponding to each game can be displayed on the LCD panel 22 on the first enclosure 20 side, there is no need to connect a game operating device as the peripheral equipment of the electronic device 1. As the electronic device 1 according to the present embodiment, the mobile game-dedicated device, the mobile terminal (PDA: personal digital assistance), or the like may be employed in addition to the PC. Also, the interface that is suitable for the game can be provided to the small-sized enclosure to which it is difficult to connect the peripheral equipment.

Master Slave

The electronic device 1 shown in FIG. 15A is used as the operating device (PC) that remote controls the automated fire-fighting engine. The connection between the electronic device 1 and the automated fire-fighting engine is implemented via a cable or radio such as radio LAN, Bluetooth, or the like.

The camera image 65 derived by shooting the automated fire-fighting engine from the camera that is installed at another place is displayed on the LCD panel 13 on the second enclosure 10 side. Also, a camera image picked up by a camera being installed into the automated fire-fighting engine can be displayed on the LCD panel 13 solely or in combination with the camera image 65. The operation interface screen 67 used to operate the automated fire-fighting engine is displayed on the LCD panel 22 on the first enclosure 20 side. If the user uses the operation interface screen 67 of the electronic device 1 as a master system and uses the automated fire-fighting engine as a slave system, such user can remote control the automated fire-fighting engine on the electronic device 1 by moving his or her finger, or the like that touches the operation interface screen 67 displayed on the LCD panel 22, while looking at the automated fire-fighting engine or a fire-extinguishing condition displayed on the LCD panel 13.

In the automated fire-fighting engine displayed on the LCD panel 13 shown in FIG. 15A, a water spraying nozzle is mounted on the engine, three rotating shafts are arranged between the engine and the water spraying nozzle such that the water spraying nozzle can be three-dimensionally moved freely with respect to the engine, and the user can remote control the driving of the engine and the spraying direction of the water spraying nozzle via the operation interface screen 67. Also, the user can adjust a pressure of the water sprayed from the water spraying nozzle when operates a slider labeled “Pressure” on the operation interface screen 67.

Also, in the case where the user executes the remote control based on the overall image of the automated fire-fighting engine displayed on the LCD panel 13 shown in FIG. 15A, even when the user cannot control a spraying angle of the water spraying nozzle with good precision, for example, the image of the details of the automated fire-fighting engine can be displayed appropriately in an enlarged fashion, as shown in FIG. 15B. Thus, the user can control such spraying angle of the water spraying nozzle with good precision. The enlarged display of the image may be obtained by moving the user's finger, or the like touching the screen around portions, in which the water spraying nozzle should be operated with good precision, to point an area and then enlarging this area, for example. Such approach permits the remote control with good precision even when the user put on his or her working gloves and the sense of the tip of the finger becomes less sharp.

Also, the automated fire-fighting engine, the water spraying nozzle, or the mechanical mechanism unit between them is equipped with at least a sensor such as a stress sensor, a temperature sensor, or the like and a communication unit for transmitting a sensed output of this sensor, an external force or a temperature applied to the automated fire-fighting engine can be measured in real time at the scene of a fire and thus the appropriate the fire-extinguishing activity can be taken. When the electronic device 1 receives the sensed output from the temperature sensor, a high temperature portion shown in red and a low temperature portion shown in blue, for example, as well as the image of the automated fire-fighting engine can be displayed on the operation interface screen 67 of the electronic device 1. When the electronic device 1 accepts the sensed output from the stress sensor, stress conditions of respective portions given in different colors, for example, as well as the image of the automated fire-fighting engine can be displayed on the operation interface screen 67.

Also, when the constituent member of the automated fire-fighting engine is deformed by the stress, the image displayed on the operation interface screen 67 can also be deformed in response to such deformation and thus a visibility of the user can be enhanced. For example, in case a top end of the rod-like constituent member is deformed by an amount of about 1/10 of the diameter, it is difficult for the user to recognize such deformation if an actual amount of deformation is reflected on the operation interface screen 67 as it is. Therefore, an amount of deformation is expanded 10 times, for example, and then an amount of deformation of the top end of the constituent member is displayed on the operation interface screen 67 in an enlarged fashion. Also, in case an excessive stress or temperature that exceeds an allowable value being set beforehand is applied, characters of a warning display may be displayed on the operation interface screen 67 or an alarm sound may be generated from the speakers (not shown).

Also, the camera image displayed on the LCD panel 13 on the second enclosure 10 side, i.e., the operating condition of the automated fire-fighting engine, together with time information can be recorded in the recording device such as HDD, or the like. Also, when a plurality of automated fire-fighting engines to be operated are present, it can be switched easily on the electronic device 1 side which automated fire-fighting engine should be operated. Thus, in case configurations of a plurality of automated fire-fighting engines are different respectively, the operating screen can be displayed on the operation interface screen 67 to respond to a plurality of automated fire-fighting engines.

Also, the electronic device 1 shown in FIG. 15A and FIG. 15B has a cylinder lock 68 that can lock when the second enclosure 10 and the first enclosure 20 are closed mutually. This cylinder lock 68 can prevent such an event that the enclosures are opened by the falling, the vibration, the impact, or the like in a disaster area or a work site in use of the electronic device 1 or during the transportation or in no use at night and then the fragile display screen is exposed and damaged. Also, it can be prevented by providing the cylinder lock 68 that a third party except the user operates the electronic device 1 without license. Thus, the security of the electronic device 1 can be enhanced.

Further, other than the remote control of the automated fire-fighting engine, the electronic device 1 can be used in the remote control of the vehicle or the robot used in a factory, a power station, a work site, etc., the operation manipulator used in a medical site, the moving camera used in a movie shooting, a sports broadcast, etc., the simple work manipulator used in a curtain opening/closing system, an illumination system, a screen lifting system, a microphone volume adjusting system, etc. in a lecture hall, the carry-in and carry-out of an article in a warehouse or a library, and others, for example.

IP Phone

The electronic device 1 shown in FIG. 16 can be used as the IP phone that communicates by using the network line. The phone interface screen 71 similar to the normal phone interface is displayed on the LCD panel 22 on the first enclosure 20 side, and information about the person on the other end of the line, the line condition, the call time, etc. are displayed on the LCD panel 13 on the second enclosure 10 side. In the electronic device 1, the user can input the phone number from the phone interface screen 71 and can connect the telephone line to the concerned phone number based on this input.

In the electronic device 1 shown in FIG. 9 to FIG. 16 respectively, the inputting of the analogue information from the LCD panel 22 on the first enclosure 20 side can be easily executed. That is, in the electronic device 1, various optimum input interfaces can be implemented and switched in response to the using situation of the operating system 400, the application softwares A, B 500, 600, etc. without connection of special hardware such as the mouse, the joy stick, or the game operating device. Also, because the hinges 30a and 30b are provided between the second enclosure 10 and the first enclosure 20, an angle between the input interface screen and the output screen can be adjusted optimally every used interface.

(Available Examples of Hardware Position Information)

Next, available examples of the hardware position information in the foregoing electronic device 1 will be explained hereunder. In the electronic device 1 shown in FIG. 17 to FIG. 18, as described above, the second enclosure 10 and the first enclosure 20 jointed swingably by the hinges 30a and 30b are provided, and also the LCD panel 22 with a pressure-sensitive touch panel is fitted to the first enclosure 20 and the LCD panel 13 is fitted to the second enclosure 10.

Connector

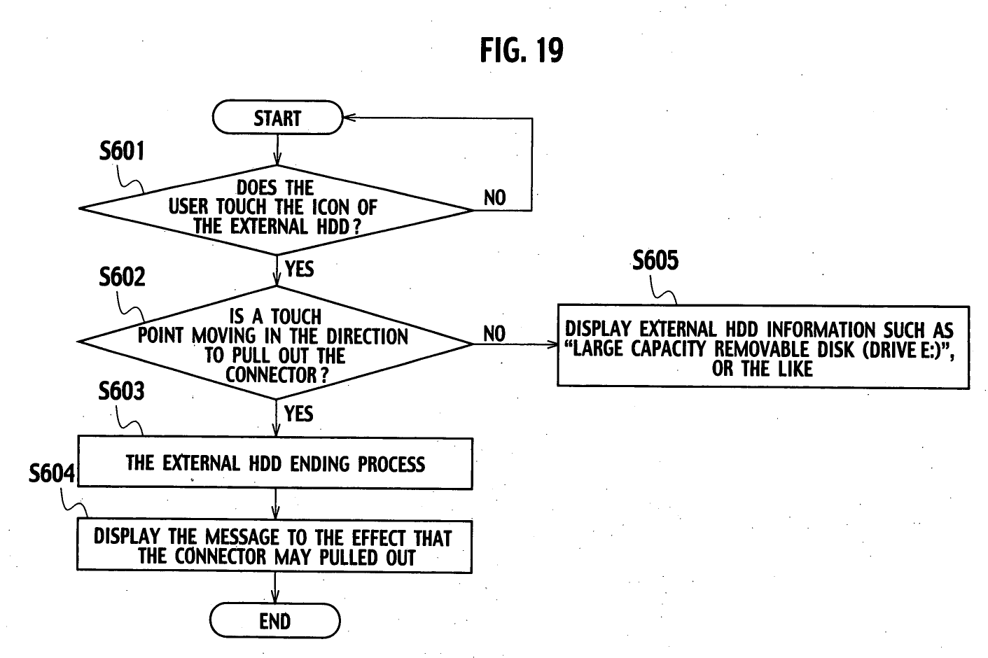

In the electronic device 1 shown in FIG. 17A and FIG. 17B, a connector for connecting the peripheral equipment such as USB, modem, LAN, or the like is provided to a side surface of the first enclosure 20. Prior to the pulling of the connector, the user executes the processing procedures such as “the safety removing process of the hardware”, etc. of the operating system 400 to write the data remaining in the cache, or the like, or to instruct an end of communication, or the like. The processing procedures are explained in FIG. 19.

The electronic device 1 shown in FIG. 17 is in its condition that the external HDD 82 is connected to this device. At this time, the HDD icon 81 showing the external HDD 82 connected to the connector is displayed near the connector on the LCD panel 22. It is decided whether or not the user touches the HDD icon 81 with the finger (step S601). If it is decided that the user does touch the icon, the process goes back to a start in a flowchart shown in FIG. 19.

If it is decided that the user touches the icon, it is decided whether or not the touch point (position) at which the user touches the HDD icon 81 is moving in the direction, as shown in FIG. 17B, to pull out the connector (step S602). Then, if it is decided that the touch point is not moving, the information of the external HDD 82 currently connected, e.g., the information of the “large capacity removable disk (drive E:)”, or the like is displayed on the LCD panel 22 (step S605).

If it is decided that the touch point is moving, the ending process of the external HDD 82 is carried out (step S603). The ending process of the external HDD 82 corresponds to the process of writing the data remaining in the above cache, or the like. Then, the message to the effect that “the connector may be pulled out” is displayed on the LCD panel 13 (step S604).

In place of the icon indicating the type of the peripheral equipment such as the HDD icon 81, an indication such as a button meaning the end of the peripheral equipment, an image showing a connector shape, a character indicating of the peripheral equipment connected to the connector, or the like may be used.

In the electronic device 1 having such functions, if the hardware position information is displayed, the user can understand intuitively which peripheral equipment is now connected and which peripheral equipment should be pulled out. In particular, in the case where the user pulls out the external HDD 82, if the user pulls out while looking at the HDD icon 81 displayed near the region to which the external HDD 82 is attached on the LCD panel 22, such user can reduce the operational mistake rather than the case where the user pulls out the external HDD based on the judgment from the name of the drive displayed on the LCD panel 13. Therefore, risks such as loss of the information stored in the external HDD 82, failure of the external HDD 82, etc. can be reduced.

Failure Location

In the electronic device 1 shown in FIG. 18, the position information of the built-in hardware can be displayed. The hardware arrangement screen 85 is displayed on the LCD panel 22 on the first enclosure 20 side of the electronic device 1.

Also, when any trouble is caused in the hardware in the electronic device 1, the hardware arrangement screen 85 indicating in which position and in what hardware the trouble is caused is displayed as a malfunction occurring location 86 on the LCD panel 22, other than the case where the electronic device is completely disabled. The user can collate the information in the malfunction occurring location 86 with the information of which the user can have a bodily sensation, e.g., a sensible temperature of an enclosure surface is extremely increased, a strange sound is generated near the place the parts is stored, there is generated a nasty smell, or the like, and then the user can decide easily to what extent the occurred trouble is serious, e.g., the power supply should be immediately turned off, whether or not the electronic device can be used continuously in a certain time, or the like. In the above electronic device 1 used in the wretched environment such as the scene of a fire or the disaster area and shown in FIG. 15, it is effective to display such malfunction occurring location 86.

(Advantages of the Present Embodiment)

In the electronic device 1 according to the present embodiment, the input operating screen can be varied in response to the user's taste, the using environment, the using purpose, etc., and various input operating screens can be displayed. Therefore, the portability, the operability, and the visibility can be improved.

Also, according to the electronic device 1 according to the present embodiment, the overall first display device 202 (LCD panel 22) can be used as the pointing device using the so-called touch panel. Therefore, a moving operation of the cursor can be executed by using the overall LCD panel 22 and thus the operability can be improved.

Also, according to the electronic device 1 according to the present embodiment, the input screen necessary for the input operation can be displayed totally on the first display device 202. Therefore, an operation such as a large movement of the user's arm, or the like to operate the external mouse, for example, can be eliminated and thus a user's labor required for the input operation can be reduced.

Also, according to the electronic device 1 according to the present embodiment, the hardware specialized in the joy stick, the game pad, or the application software except the mouse can be displayed as the input operating screen. Therefore, there is no need to purchase separately the input operating device, and a cost required to purchase the input operating device can be reduced. In addition, because this type hardware is apt to become the useless input operating device that lacks the versatility and has a low frequency of the use. In the electronic device 1 according to the present embodiment, since the useless input operating device can be deleted, the environmental pollution and the waste of resources can be reduced.

Also, according to the electronic device 1 according to the present embodiment, like a combination of the keyboard and the pointing device, the input operating device used frequently together with the first display device 202 can be displayed. Therefore, the operability can be improved.

Also, in the notebook PC in the prior art, the character can be input by displaying the software keyboard on the screen and then touching the virtual keyboard with the finger. However, the keyboard is arranged planarly on a top surface of the desk toward the user such that a surface of the display has an angle that is almost perpendicular to the top surface of the desk. In this case, since an angle of the surface that is suitable for the inputting is different from an angle of the surface that is suitable for the monitoring, there is a limit to improve the input operating environment by attaching a function of the touch panel to a sheet of display panel. According to the electronic device 1 according to the present embodiment, because two display devices consisting of the first display device 202 and the second display device 100 are provided, the input environment can be improved by jointing both display devices swingably by the hinges 30a and 30b.

Also, in the notebook PC in the prior art, in case keys of the full keyboard are not required in the place to which the user carries the notebook PC, such a situation is sometimes inconvenient to the user that all key inputs of the full keyboard are permitted to avoid the incorrect input. Otherwise, in the field of the notebook PC, there is the mobile PC that has no keyboard but has required minimum input devices such as a display, a power switch, and the like in a rectangular enclosure in appearance. But the versatility of the PC is impaired if the hardware is connected to such PC in the particular situation, which is disadvantageous in dealing with the sudden change of the working subject in the place that the user with the PC visits. According to the electronic device 1 according to the present embodiment, since the input operating device (input interface screen) can be changed in response to the situation, the situation adaptability can be improved.

Also, in the notebook PC in the prior art, since the touch sound is generated during the input operation of the mechanical keyboard, such touch sound acts as a noise in the library, the school hours of the school, etc. and thus it is difficult to use the PC in the quiet environment. According to the electronic device 1 according to the present embodiment, since generation of the touch sound in the input operation can be prevented by using the touch panel, or the like, the quietness can be improved.

Also, in the notebook PC in the prior art, the connector to which USB used to expand the functions is connected and the slot into which the card is inserted are provided. The external HDD 82, the optical disk drive, the memory card, or the like being connected via the USB or the card needs the ending process such as the writing all information remaining in the cache, or the like into the peripheral equipment, or the like when such device is pulled out from the PC. In pulling out the device in compliance with the ending process such as “the safety removing process of the hardware”, etc. of the operating system 400, the user checks the correspondence between the position of the connector or the slot, to which the peripheral equipment is connected actually, and the displayed drive name. However, in case a plurality of peripheral equipments are connected, there is a possibility that the user pulls out not the peripheral equipment that executes the ending process by the software but the peripheral equipment now in use due to his or her wrong operation and thus the information to be saved in the peripheral equipment, which executes the ending process by the software, are lost. In addition, such operation leads to the failure of the peripheral equipment. According to the electronic device 1 according to the present embodiment, the user can execute the information processing about the hardware, based on the input signal converted by the converting means 300, e.g., by touching the icon displayed on the first display device 202, or the like. For example, in case the external HDD 82 is connected to the electronic device 1, the user can save the information remaining the cache in the external HDD 82 by touching the HDD icon 81 displayed on the first display device 202 with his or her finger. In other words, according to the electronic device 1, loss of the information in removing the peripheral equipment or failure of the peripheral equipment in removing the peripheral equipment can be prevented.

Also, according to the electronic device 1 according to the present embodiment, since the emulation information buffers 403, 403a are provided, there is no necessity to receive all the emulation information from the application softwares A, B 500, 600 when the same emulation information as the emulation information that have already been stored in the emulation information buffers 403, 403a is to be used. The emulation information in the emulation information buffers 403, 403a can be used if the identification number of the emulation information stored in the emulation information buffers 403, 403a coincide with that of the required information. Consequently, since the electronic device 1 can reduce the number of times the interface switching means must be operated, a power consumed in the information processing can be reduced by shortening a switching time.

Also, according to the electronic device 1 according to the present embodiment, the display mode of the operating device can be changed in response to the position information of the input device 201. For example, when the image of the virtual keyboard 42 is displayed as the operating device, a color of the image of the location that the user's finger touches can be changed.

Also, according to the electronic device 1 according to the present embodiment, the communicating means (the communication module 700e, the antenna, etc,) for transmitting the converted input signal to the outside is provided. Therefore, for example, if the camera image 65 is displayed on the second display device 100 and also the operation interface screen 67 of the automated fire-fighting engine picked up in the camera image 65 is displayed on the first display device 202, the remote control of the automated fire-fighting engine can be implemented by utilizing the electronic device 1.

Also, according to the electronic device 1 according to the present embodiment, the hardware position information holding portion 703 for holding the position information of the built-in or external hardware is provided. Therefore, the position of the hardware can be displayed on the first display device 202, and the user can easily confirm visually the hardware configuration and can cope with the trouble quickly when some trouble occurs in the hardware, or the like.

Also, according to the electronic device 1 according to the present embodiment, since only the required minimum keys for the particular work can be displayed as the virtual keys on the display device with the touch panel by switching the emulation information, such a situation can be prevented that the user touches the unnecessary key to cause the unintended operation. In addition, in the electronic device 1, the keyboard having the (easy-use) key arrangement that corresponds to the user's input operation can be displayed. Further, in the electronic device 1, operational authorities can be allocated more clearly to the manager and the users except the manager. For example, in case the electronic device 1 is used by an unspecified large number of users in the traffic facility guiding system, the Internet cafe, etc., such electronic device 1 can give high security. Furthermore, according to the electronic device 1 according to the present embodiment, various interfaces that cannot be handled by the mechanical keyboard can be realized.

### Other Embodiments

The present invention is described with reference to above embodiments, but it should be interpreted that the discussion and the drawings constituting a part of this disclosure are not applied to limit this invention. It is apparent for the person skilled in the art that various alternative embodiments, examples, and implementation technologies may be applied from this disclosure.

For example, in the embodiment of the present invention, the notebook PC is exemplified as the electronic device 1. But the present invention is not limited to this, and the present invention may be applied to the information equipment such as the personal computer (PC), the electronic note, PDA, the cellular phone, and the like.

Also, according to the electronic device 1 shown in FIG. 4, the interface switching module 700a, the converting module 700b, etc. are installed into one CPU 700. In the present invention, respective modules may be installed into the device other than the CPU 700.

Also, according to the electronic device 1 shown in FIG. 4, the emulation information holding portion 701, and the hardware position information holding portion 703 are built up by separate memory devices. In the present invention, both holding portions may be constructed by one memory device.

In this manner, it is of course that the present invention contains various embodiments, etc. that are not recited herein. Accordingly, the technical scope of the present invention should be decided only by the particular matters of the invention according to the claims that are adequate from the above disclosure.

As explained above, according to the embodiment of the present invention, the electronic device 1 that is excellent in portability, operability, situation adaptability, and quietness, the control method, and the control program can be provided.

What is claimed is:

1. An electronic device, comprising:
a first display device having a display screen;
an input device configured to acquire a first information indicating a touch position on the display screen;
a storing device configured to store emulation information used to convert the first information into a second information indicating a touch position on an operating system; and
a converting unit configured to convert the first information indicating the touch position acquired by the input device into the second information indicating the touch position on the operating system, based on the emulation information stored in the storing device.

2. An electronic device according to claim 1, further comprising:
a second display device having a display screen;
wherein the second display device displays the second information converted by the converting unit on the display screen.

3. An electronic device according to claim 1, further comprising:
a display controlling unit configured to change an input interface screen of the input device.

4. An electronic device according to claim 2, further comprising:
a display controlling unit configured to change an input interface screen of the input device.

5. An electronic device according to claim 1, further comprising:
a communicating unit configured to transmit the second information converted by the converting unit to an external device.

6. An electronic device according to claim 4, further comprising:
a hardware position information holding unit configured to hold a position information of a built-in hardware.

7. An electronic device according to claim 6, wherein the display controlling unit carries out the control which displays a position of the hardware on the display screen of the first display device, which corresponds to the position information of the hardware position information holding unit.

8. An electronic device according to claim 4, further comprising:
a hardware position information holding unit configured to hold a position information of an external hardware.

9. An electronic device according to claim 8, wherein the display controlling unit carries out the control which displays a position of the hardware on the display screen of the first display device, which corresponds to the position information of the hardware position information holding unit.

10. An electronic device according to claim 6, further comprising:
a data processing unit configured to execute a data processing of the hardware.

11. An electronic device according to claim 8, further comprising:
a data processing unit configured to execute a data processing of the hardware.

12. An electronic device according to claim 1, further comprising:
an emulation information buffer to store the emulation information.

13. An electronic device according to claim 12, wherein the emulation information buffer is formed in the operating system.

14. An electronic device according to claim 12, wherein the emulation information buffer is connected to the converting unit.

15. An electronic device according to claim 2, further comprising:
a hinge to joint swingably the first display device and the second display device.

16. An electronic device control method, comprising:
displaying an input interface screen on a display screen of a first display device;
acquiring a position that is touched in an input device on the input interface screen, as a first information;
storing an emulation information used to convert the first information into a second information indicating a touched position on an operating system; and
converting the first information into the second information indicating the touched position on the operating system, based on the emulation information.

17. An electronic device control method according to claim 16, further comprising:
displaying the second information on a display screen of a second display device.

18. An electronic device control method according to claim 17, wherein the emulation information is stored in an emulation buffer, and when an emulation information same as the emulation information stored in the emulation buffer is used, the first information is converted into the second information by using the emulation information stored.

19. An electronic device control program, comprising:
displaying an input interface screen on a display screen of a first display device;
acquiring a position that is touched in an input device on the input interface screen, as a first information;
storing an emulation information used to convert the first information into a second information indicating a touched position on an operating system; and
converting the first information into the second information indicating the touched position on the operating system, based on the emulation information.
